(19) United States
(12) Patent Application Publication
(10) Pub. No.: US 2026/0025074 A1
(43) Pub. Date: Jan. 22, 2026

(54) LINKED PHASES IN A MULTIPHASE POWER CONVERTER

(71) Applicant: Texas Instruments Incorporated, Dallas, TX (US)

(72) Inventors: Matthew Schurmann, Wylie, TX (US); Vikram Gakhar, Karnataka (IN); Amrutheshwara Rao KV, Bangalore (IN); Harshith S, Bangalore (IN); Preetam Charan Anand Tadeparthy, Richardson, TX (US)

(21) Appl. No.: 18/895,863

(22) Filed: Sep. 25, 2024

Related U.S. Application Data
(60) Provisional application No. 63/673,380, filed on Jul. 19, 2024.

(51) Int. Cl. H02M 3/158; H02M 3/157

(52) U.S. Cl. CPC H02M 3/1584; H02M 3/157

(57) ABSTRACT

A controller for a multiphase power converter includes a counter configured to receive a clock signal and output a count signal having a count value that sequentially counts from 0 to N in phase with the clock signal, where N is equal to a number of phases of the multiphase power converter, and a plurality of drive stages. Each drive stage is configured to receive the count signal from the counter and, based on the count value, output a corresponding pulse width modulation (PWM) signal. At least two of the plurality of drive stages are configured to output their corresponding PWM signals in response to receiving the count signal having a same count value.

### CROSS REFERENCE TO RELATED APPLICATION

This application claims the benefit of and priority to U.S. Provisional Application No. 63/673,380 filed on Jul. 19, 2024, which is hereby incorporated by reference in its entirety.

### TECHNICAL FIELD

This description relates to power converters, and more particularly, to multiphase direct current (DC)/DC converters.

### BACKGROUND

Power converters (such as DC-DC converters) are widely used in electronic systems such as consumer electronics, automotive systems, industrial equipment, lighting systems, etc. for converting an input voltage to an output voltage higher or lower than the input voltage. Such converters utilize a power switch that turns on and off to regulate the output voltage. A feedback loop along with a controller is also used to determine the on or off time of the transistor in each switching cycle based on the feedback voltage representative of the power converter output voltage, and a reference voltage, thereby regulating the output voltage of the power converter. A multiphase power converter may be used in applications that require high current loads (e.g., hundreds of amps). There remain challenges in providing optimal control of the multiple phases in the multiphase power converter.

### SUMMARY

According to an embodiment, a circuit includes a counter configured to receive a clock signal and output a count signal having a count value that sequentially counts from 0 to N in phase with the clock signal, where N is equal to a number of phases of a multiphase power converter, and a plurality of drive stages. Each drive stage is configured to receive the count signal from the counter and, based on the count value, output a corresponding signal. At least two of the plurality of drive stages are configured to output their corresponding signals in response to receiving the count signal having a same count value.

According to another embodiment, a power converter system includes a multiphase controller and a plurality of power converter stages. The multiphase controller includes a control loop block and a phase manager. The control loop block includes a reference voltage circuit configured to generate a reference voltage and a voltage comparator having a first input configured to receive the reference voltage, a second input configured to receive a feedback voltage from an output of the power converter stages, and an output configured to provide a drive signal. The phase manager includes a counter configured to receive a clock signal and output a count signal having a count value that sequentially counts from 0 to N in phase with the clock signal, where N is equal to a number of phases, and a plurality of drive stages. Each drive stage is configured to receive the count signal from the counter and, based on the count value, output a corresponding pulse width modulation (PWM) signal. At least two of the plurality of drive stages are configured to output their corresponding PWM signals in response to receiving a count signal having a same count value. Each of the power converter stages corresponds to a drive stage of the plurality of drive stages and is configured to receive the PWM signal output by the drive stage.

According to another embodiment, a phase manager circuit includes a counter configured to receive a clock signal and output a count signal having a count value that sequentially counts from 0 to N in phase with the clock signal, and at least two drive stages each configured to output a corresponding signal. The clock signal is based at least on a number of phases of the multiphase power converter and on an undershoot signal. The undershoot signal is based at least on a transient switching response time of the phase manager circuit. N is equal to the number of phases. The at least two of the plurality of drive stages are further configured to output their corresponding signals upon receiving count signals with different count values from the counter if the undershoot signal is in a first state, and are configured to output their corresponding signals upon receiving a count signal with a same count value from the counter if the undershoot signal is in a second state.

### BRIEF DESCRIPTION OF THE DRAWINGS

FIG. 1A is a block diagram illustrating current provided to a load by a DC/DC power converter.

FIG. 1B illustrates an example load current transient waveform.

FIG. 2 is a more detailed block diagram showing a multiphase power converter delivering current to a load device, in an example.

FIG. 3 is a block diagram showing a control loop block within a controller of the multiphase power converter, in an example.

FIG. 4 is a block diagram showing a phase manager within the controller of the multiphase power converter, in an example.

FIG. 5A is a block diagram showing linked drive stages within the phase manager, in an example.

FIG. 5B is a first timing diagram showing how the PWM signals of more than one stage are output together off of the same drive signal, in an example.

FIG. 5C is a second timing diagram showing how the PWM signals of more than one drive stage are output together off of the same drive signal, in an example.

FIG. 6A is a block diagram showing dynamically linked drive stages based on a state of an undershoot signal, in an example.

FIG. 6B is a timing diagram showing how the PWM signals of more than one dynamically linked drive stage are output together off of the same drive signal when the undershoot signal is asserted, in an example.

FIG. 7 is a schematic diagram of a controller coupled to a single power converter stage, in an example.

### DETAILED DESCRIPTION

In an example, a controller for a multiphase power converter is designed to activate more than one phase (e.g., power converter stage) at substantially the same time in order to provide a greater amount of load current in a shorter period of time to meet high-current load demands. A counter within the controller sequentially counts through a number of phases to be activated while drive stages are used to determine the current value of the counter and to output the drive signals for the corresponding power converter stages. Such drive stages may be activated in sequence along with the counter and at a frequency that cannot be lower than a given blanking interval. However, according to some embodiments, two or more of the drive stages are designed to activate upon receiving the same count value, such that their drive signals are output at substantially the same time. In this way, the amount of current that can be sourced in a given timeframe is increased. In one example, the two or more drive stages are hardwired to activate together when receiving a particular same count value. In another example, the two or more drive stages are dynamically linked such that they activate together on the same count value during the transient switching response time of the multiphase power converter. The two or more drive stages may be activated upon receiving different count values when the multiphase power converter operates outside of the transient switching response time. Numerous other variations will be apparent based on the embodiments described herein.

### General Overview

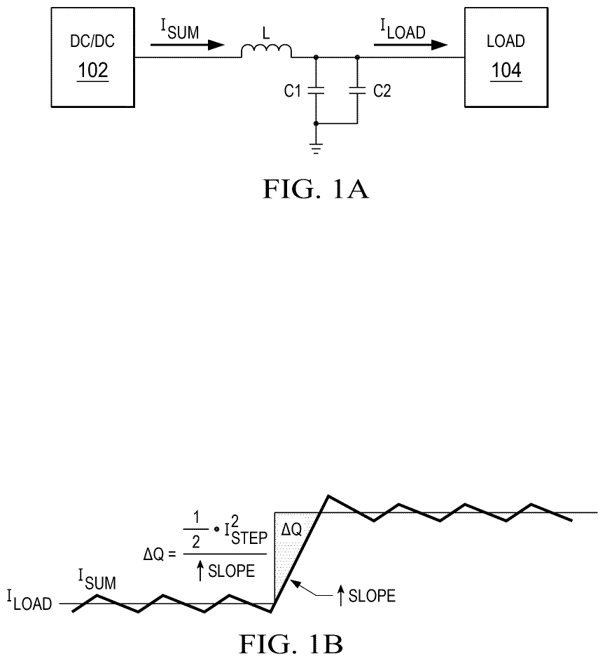

As described above, multiphase DC/DC power converters are used in many applications to supply on-demand and relatively stable voltage and current to a load. FIG. 1A illustrates an example block diagram of a DC/DC power converter 102 that generates an output current I_{SUM}, which passes through one or more inductors L to provide a DC load current ILOAD to the load 104. The output current I_{SUM} represents the sum of all currents provided from each of the power converter stages in DC/DC power converter 102. Each stage supplies a part of the total current I_{SUM}. When the current demand suddenly rises at load 104, the multiphase power converter keeps up with the new demand by firing off additional power converter stages, with each power converter stage capable of supplying a given maximum current. This is generally represented by the waveforms illustrated in FIG. 1B where the load current demand sharply rises causing the output current I_{SUM} to rise in order to keep up with the demand. The time over which I_{SUM} is rising is known as the transient switching response time of the DC/DC power converter 102, and it is typically desirable for the transient switching response time to be as short as possible. The output capacitors C1 and C2 illustrated in FIG. 1A affect the slope of I_{SUM} during the transient switching response time.

As load demands continue to increase, such as in certain devices of high-end computing devices (e.g., graphical processing units, enterprise servers), higher switching frequencies are required in order for the multiphase power converter to supply the load demand in the allotted time. But system constraints that affect the slope of I_{SUM} during the transient switching response time, such as a blanking interval that dictates how quickly the different power converter stages can be activated, put a practical limit on how fast multiphase power converters can supply the required current load. As a result, simply adding more power converter stages is not enough to overcome the inability to switch between them quickly enough to meet the load demand of some devices.

Thus, in accordance with some embodiments of the present disclosure, a phase manager architecture for use within a multiphase DC/DC power converter is described. The phase manager controls the timing of when to activate the various power converter stages of the multiphase DC/DC power converter. According to some embodiments, the phase manager includes a counter that sequentially counts from 0 to N, where N is equal to a number of phases of the multiphase DC/DC power converter. The counter output is received by a number of drive stages, with each drive stage associated with a given power converter stage of a plurality of power converter stages. Each drive stage determines, based on the count value of the received counter output, whether to output a pulse width modulated (PWM) signal to activate the associated power converter stage. In one example embodiment, two or more of the drive stages are hardwired to output their corresponding PWM signals upon receiving the same count value. Accordingly, the associated power converter stages activate at substantially the same time to provide their combined current at substantially the same time. In another example embodiment, two or more of the drive stages are dynamically linked to output their corresponding PWM signals upon receiving the same count value during a first time period, and to output their corresponding PWM signals upon receiving different count values during a second time period that does not overlap with the first time period. In an example, the first time period may represent the transient switching response time (or at least a portion of the transient switching response time) during which the output current is rising to meet a higher load demand. The second time period may represent any other time during which the output current from the multiphase DC/DC power converter is at a relatively steady state (e.g., any time outside of the transient switching response time). Numerous other variations will be apparent based on the example embodiments described herein.

### Electronic System

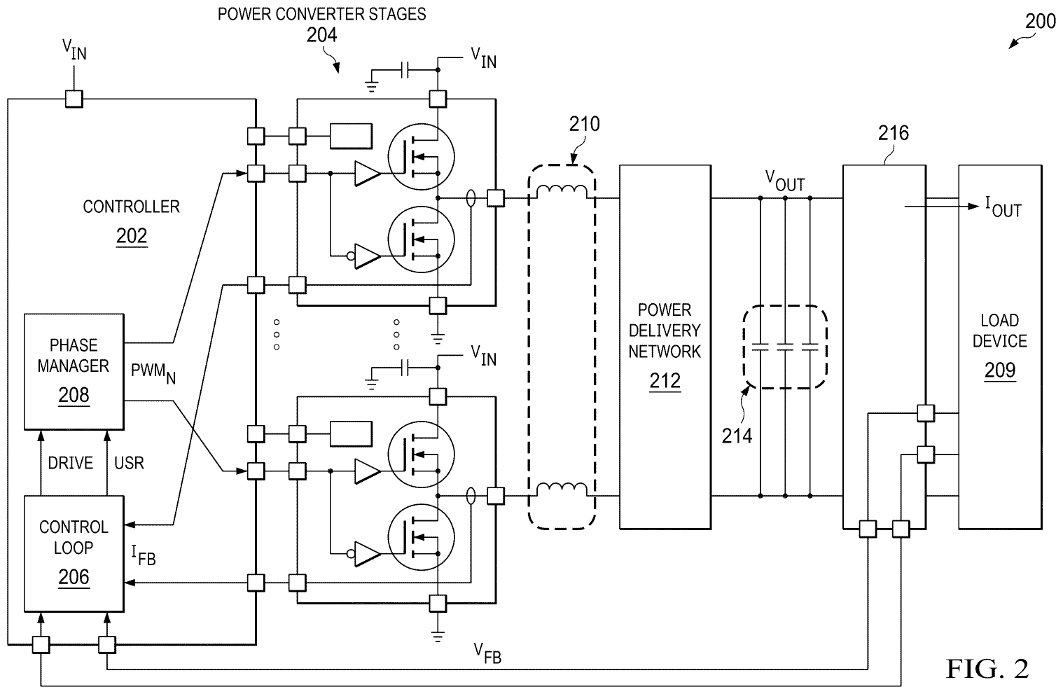

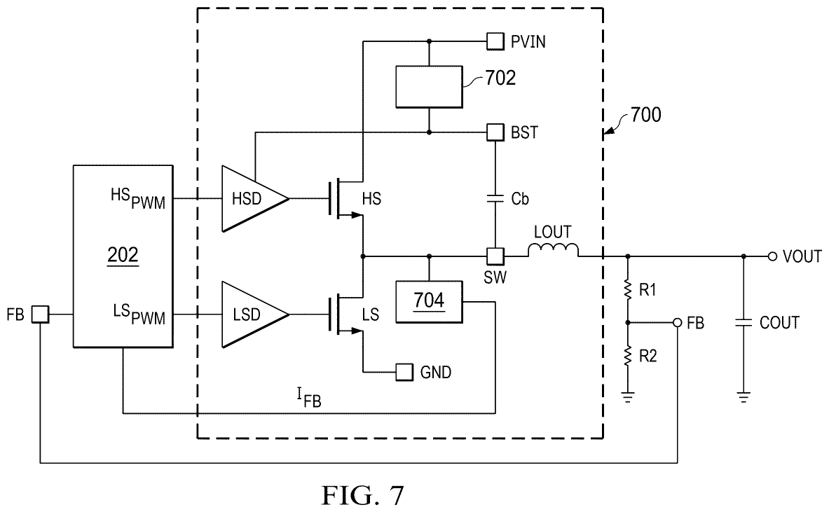

FIG. 2 illustrates an example diagram of at least a portion of an electronic system 200 that includes a multiphase power converter with a controller 202 and a plurality of power converter stages 204. Further details of each power converter stage 204 are provided with reference to FIG. 7, in accordance with some embodiments. Electronic system 200 may be implemented on a printed circuit board (PCB) or across more than one PCB. Controller 202 and power converter stages 204 may be implemented as a system-on-chip, or as a chip set populated on a PCB, or as a set of discrete components populated on a PCB, which may in turn be populated into a chassis of a multi-chassis system or an otherwise higher-level system, although any number of implementations can be used. Controller 202 may receive an input voltage (VIN) from a system bus or any voltage source within, for example, a computing environment. In some embodiments, controller 202 is coupled to other computing components, such as a board management controller (BMC) to facilitate communication across a network.

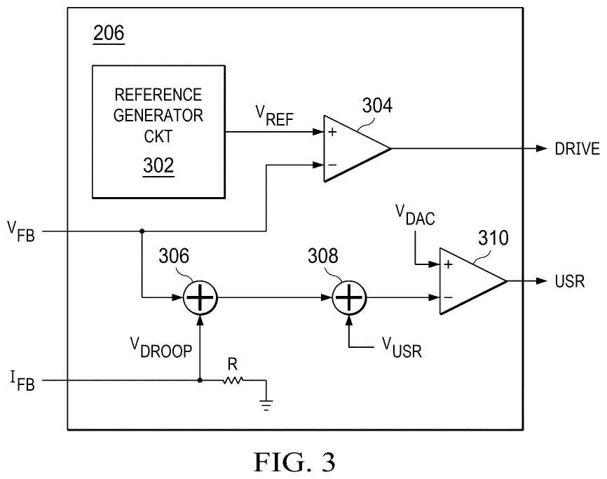

According to some embodiments, controller 202 includes at least a control loop 206 and a phase manager 208, which are used to control the timing of pulse width modulated output signals (PWM_{N}) that are used to drive up to N different power converter stages 204. Briefly, control loop 206 receives various feedback signals in the form of current feedback I_{FB} from one or more of power converter stages 204 and voltage feedback V_{FB} from the load device 209 to produce output signals such as a drive signal and an undershoot reduction signal (USR). In some examples, the voltage feedback V_{FB} is received across two terminals that provide a differential voltage, and the difference between the two terminals provides the magnitude of the voltage feedback V_{FB} (e.g., one terminal has the positive or higher voltage and the other terminal has the negative or lower voltage). In some examples, the voltage feedback V_{FB} is received on a single terminal. Further details of control loop 206 are provided with reference to FIG. 3.

Phase manager 208 receives the drive and USR signals produced by control loop 206 and uses these signals along with an internal counter and a plurality of drive stages to determine the state of the PWM_{N} signals, which in turn drive the operation of up to N different power converter stages 204. It should be noted that, in some applications, only a subset of the total number of power converter stages 204 are activated to deliver the demanded load current.

Output current is produced by each of the activated power converter stages 204 and is passed through any number of inductors 210 to produce a smoother DC current output that is summed across all of the activated power converter stages 204. The total output current is delivered across a power delivery network 212 to reach load device 209 as I_{OUT} with the output potential V_{OUT} across any number of coupling capacitors 214. A board interface 216 may be used to facilitate the transfer of the signals from power delivery network 212 to load device 209. Board interface 216 may represent any connection interface between power delivery network 212 and load device 209, such as a socket or solder interface. Power delivery network 212 may represent any conductive pathways across which current can travel, such as metallic traces on a PCB. Coupling capacitors 214 may be designed in ways to reduce the transient switching response time by providing faster switching times between the different power converter stages 204. However, changing the size and/or total number of coupling capacitors 214 is costly and takes up precious space on a given die, thus making it an impractical solution to improving transient performance.

FIG. 3 illustrates a block diagram of control loop 206, according to an embodiment. Control loop 206 includes a reference generator circuit (CKT) 302 that generates a voltage reference V_{REF} to be compared against a feedback voltage V_{FB} that is sampled from the load. As noted above, feedback voltage V_{FB} may be received over a single terminal for a single ended signal or across two terminals (e.g., differential volage). In some embodiments, reference generator circuit 302 includes a bandgap voltage reference circuit. A bandgap voltage reference circuit may refer to any circuit that attempts to generate a stable voltage reference independent of changes in temperature and supply voltage. Briefly, a bandgap voltage reference circuit typically includes a voltage reference generator, a temperature sensor, and a current source. The voltage reference generator produces a stable reference voltage, which may be based on a combination of bipolar junction transistors (BJTs) and diodes. The temperature sensor measures the temperature of the circuit and generates a compensating voltage that is added to the reference voltage to cancel out the temperature dependence of the circuit. The current source may be used to bias the BJTs and diodes in the voltage reference generator.

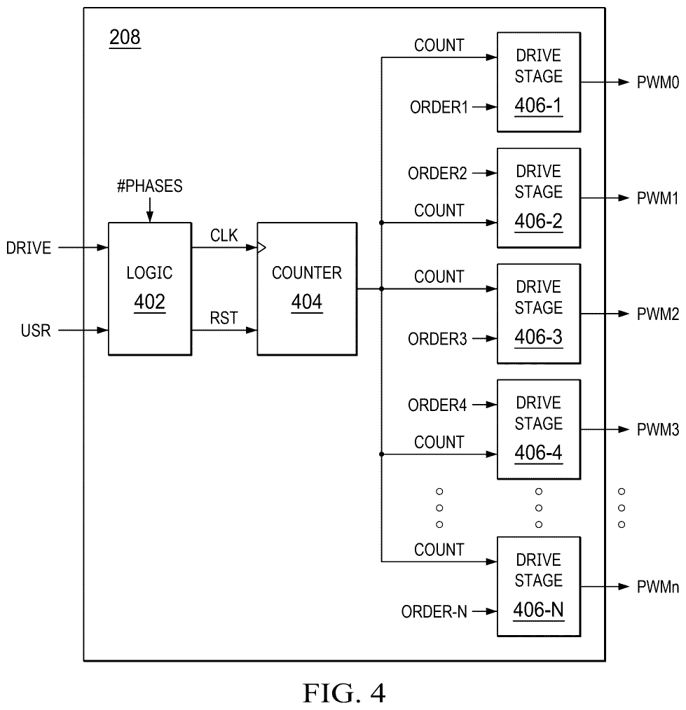

The state of the drive signal is determined by comparing the feedback voltage V_{FB} to reference voltage V_{REF} at a comparator 304. Accordingly, the drive signal will pulse HIGH when the feedback voltage falls below V_{REF}. The reference voltage V_{REF} is a stable potential value that is provided by reference generator circuit 302. The drive signal is received by phase manager 208, which in turn activates any number of power converter stages 204 based at least on the state of the drive signal, as described in more detail with reference to FIG. 4.

As discussed above, the USR signal is provided to phase manager 208 as a way to inform phase manager 208 that the load current demand has suddenly changed and that the output current from the power converters needs to quickly increase to meet the demand. In other words, the system is within the transient switching response time when the USR signal is asserted. According to some embodiments, the state of the USR signal is determined by control loop 206 and is generally based on a voltage comparison between the current output voltage and one or more voltage thresholds. One example implementation for determining the state of the USR signal is illustrated in FIG. 3 where the feedback voltage V_{FB} is added at a first adder 306 to a droop voltage (V_{DROOP}), which can be determined using the current feedback I_{FB} from the power converter stages 204 across a resistor R. The current feedback I_{FB} represents the sum of the feedback currents collected from each of power converter stages 204, according to some embodiments. The output of first adder 306 is then summed with a USR threshold voltage V_{USR} at a second adder 308. USR threshold voltage V_{USR} may generally represent the amount of change or droop in the output voltage that is needed to indicate that the system has entered into the transient period and that the output current needs to quickly rise to meet a higher load demand. The output of second adder 308 is then compared with another voltage threshold V_{DAC} at a comparator 310, according to some embodiments. V_{DAC} represents the target voltage level at which the power converter system is trying to regulate the voltage (e.g., the target output volage of the system). If the output voltage falls far enough such that the output of second adder 308 falls below the value of V_{DAC}, then the USR signal is asserted high indicating that the power converter is operating within the transient response period. Control loop 206 may be designed to provide at least the drive signal and the USR signal to phase manager 208.

FIG. 4 illustrates a more detailed block diagram of phase manager 208, according to some embodiments. As can be seen on the left side of the figure, phase manager 208 receives at least the drive signal and the USR signal from control loop 206. A logic block 402 may receive these signals along with a #phases signal, which may be a programmable value to indicate the total number of phases (e.g., power converter stages 204 or linked groups of power converter stages 204) to be activated for a given current load. According to some embodiments, logic block 402 uses the drive signal, USR signal, and #phases signal to determine how quickly the different power converter stages 204 or linked groups of power converter stages 204 should be activated to meet the current demand. This frequency of power converter stage activation is represented by the CLK signal produced by logic block 402. The CLK signal then drives the counting frequency of counter 404. A reset signal RST is also produced to inform counter 404 to return counting back at 0, such that only the necessary number of power converter stages 204 or linked groups of power converter stages 204 are used. In some embodiments, logic block 402 utilizes any number of latches and delays to control the pulse width of the CLK signal. For example, the drive signal may be received by a latch and the latch output (e.g., the CLK signal) is asserted HIGH in response. After a first delay, the latch is reset and the CLK signal is brought back LOW, giving the CLK signal a pulse width that is roughly equal to the first delay. The inverted latch output may be feed through a second delay to determine how long to wait after the CLK has been brought low to reassert the CLK signal as HIGH again, thus repeating the process with the latch. The total delay of the first delay and the second delay sets the blanking interval for the system, according to some embodiments.

According to some embodiments, counter 404 produces a count signal having a count value that is received by each of a plurality of N drive stages 406-1 to 406-N. Each drive stage is designed to output a PWM signal to a corresponding power converter stage 204 to drive the operation of that corresponding power converter stage 204. Each drive stage 406 is designed to compare the received count signal to a corresponding order signal and, if the count signal matches the order signal, the drive stage 406 outputs a PWM signal to drive the corresponding power converter stage 204 to generate output current. According to some embodiments, two or more drive stages 406 may share the same order signal or receive order signals having the same value, such that the linked drive stages 406 will provide their corresponding PWM signals at substantially the same time (e.g., upon receiving the same count value from counter 404). In an example, drive stages 406-1 and 406-2 are linked together such that order1 and order2 provide the same value, and drive stages 406-3 and 406-4 are linked together such that order3 and order4 provide the same value. Any number of different drive stages 406 may be linked together in this way to form any number of linked groups of drive stages. In some examples, all N drive stages are linked together to output their corresponding PWM signals at substantially the same time.

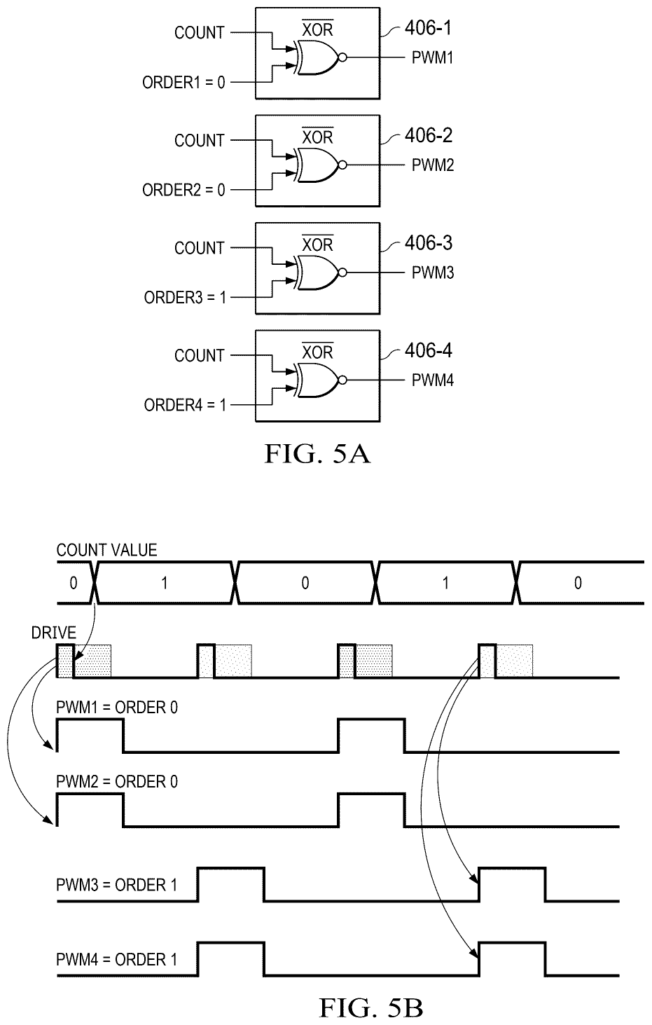

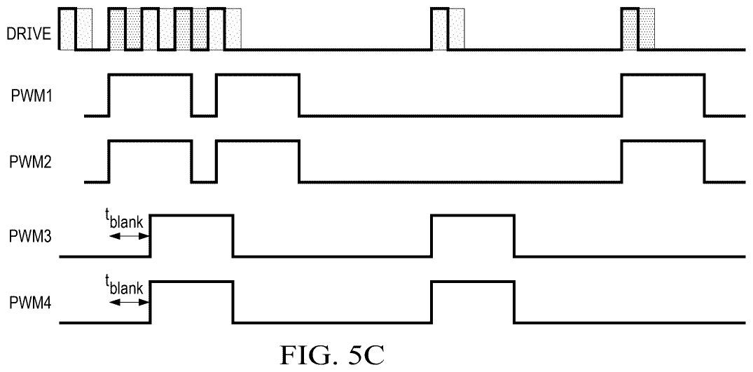

According to an embodiment, each instance of the order signal represents a hardwired or static value for comparing against the count value. For example, both the order1 signal and the order2 signal applied to drive stages 406-1 and 406-2, respectfully, may have a ‘0’ bit value such that drive stages 406-1 and 406-2 output their PWM signals together when the count value is 0. Similarly, both the order3 signal and the order4 signal applied to drive stages 406-3 and 406-4, respectfully, may have a ‘1’ bit value such that drive stages 406-3 and 406-4 output their PWM signals together when the count value is 1. In some embodiments, each order signal remains static during runtime but may be programmable to apply to different applications. This example implementation is illustrated in more detail in FIG. 5A where each drive stage 406-1 through 406-4 are shown to include at least an exclusive NOR gate for comparing the count value to the corresponding order value. It should be noted that other logic gates and/or circuit elements may also be present within each drive stage 406, to control, for example, the length of the pulse for each PWM signal. The illustrated exclusive NOR gate compares a single bit count value to a single bit order value. However, in many applications, drive stages 406-1 through 406-4 are used to compare multibit signals and would include multi-bit digital components. Such multi-bit digital components may include any number of exclusive NOR gates and/or other similar digital logic to compare multibit data, however, the concept is similar to the single-bit comparison illustrated in FIG. 5A.

FIG. 5B illustrates an example timing diagram for various signals including the PWM signals output by the aforementioned drive stages 406-1 through 406-4. In this example, two sets of linked drive stages are used, so the counter only needs to count from 0 to 1 to activate each set of linked drive stages before returning back to 0. According to an embodiment, when the drive signal is asserted, the linked drive stages receiving the corresponding order signals that match the current count value will output their PWM signals. In the illustrated example, drive stages 406-1 and 406-2 output their PWM signals (PWM1 and PWM2) in response to the drive signal being asserted on the count value 0 (since drive stages 406-1 and 406-2 respectfully receive an order1 signal of 0 and an order2 signal of 0), and drive stages 406-3 and 406-4 output their PWM signals (PWM3 and PWM4) in response to the drive signal being asserted on the count value 1 (since drive stages 406-3 and 406-4 respectfully receive an order3 signal of 1 and an order4 signal of 1). In this way, more current can be supplied at each instance of the drive signal as each power converter stage is capable of providing some max current value (e.g., up to 20, 30, 40, or 50 A).

Note in FIG. 5B the presence of the shaded regions proceeding each rising edge of the drive signal. These regions each represent the blanking interval, which is a predetermined delay, as discussed above with reference to logic block 402, during which no additional power converters can be activated. The different shading is used to help distinguish between blanking intervals of adjacent pulses. FIG. 5C illustrates another timing diagram example where the blanking interval causes a more profound effect on the switching outcome. Similar to the timing diagram in FIG. 5B, the PWM1 and PWM2 signals are asserted together as are the PWM3 and PWM4 signals. However, the different linked groups of drive stages are constrained in how quickly they can be activated in sequence. In other words, they cannot be activated in sequence any quicker than the blanking interval t_{blank}. The presence of the blanking interval is one reason that power converter stages cannot simply be activated at whatever frequency is needed to meet the current demand. The blanking interval also cannot be easily changed as it is generally driven by noise immunity requirements and logic delays in both control loop 206 and phase manager 208. Thus, and in accordance with some embodiments, the ability to activate multiple power converter stages at substantially the same time can overcome the limitations imposed by the blanking interval.

Returning to FIG. 4, and in accordance with some embodiments, any of the order signals may be a dynamic signal that changes based on the status of the system or based on some feedback received by the system. For example, the order signal may change based on the status of the USR signal, which generally represents whether the system is operating within the transient response period. As noted above, during the transient response period, controller 202 may activate more power converter stages 204 and/or increase the switching frequency between power converter stages 204 to quickly supply greater current to the load. According to some embodiments, the value of the order signal received by a given drive stage 406 may change depending on the state of the USR signal to affect when different drive stages are linked together.

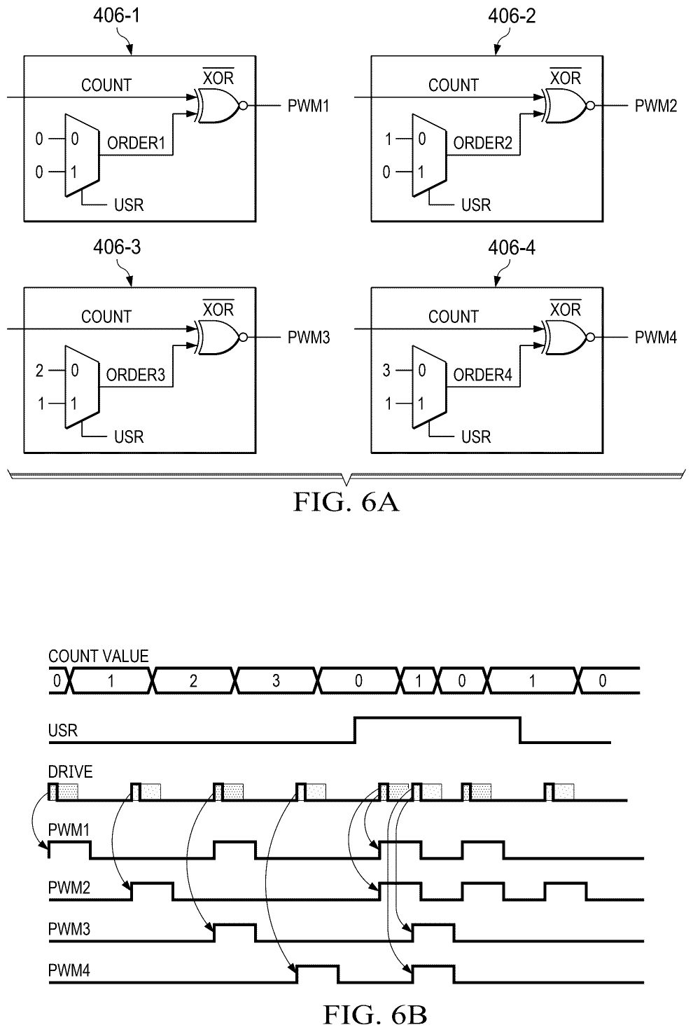

FIG. 6A illustrates an example implementation of dynamically controlling when various drive stages are linked to activate together, according to some embodiments. Each drive stage may include at least an exclusive NOR gate to compare the count value with the ORDER value as discussed above in FIG. 5A. The illustrated exclusive NOR gate compares a single bit count value to a single bit ORDER value selected based on the state of the USR signal. However, in many applications, drive stages 406-1 through 406-4 are used to compare multibit signals and would include multi-bit digital components. Such multi-bit digital components may include any number of exclusive NOR gates and/or other similar digital logic to compare multibit data, however, the concept is similar to the single-bit comparison illustrated in FIG. 6A.

According to some embodiments, the value of each order signal (e.g., order1, order2, order3, or order4) is not a constant value, but can be changed based on the state of the USR signal. According to an embodiment, the USR signal is used as the select line to a multiplexer that choses between different values for the corresponding order signal, as illustrated in each of drive stages 406-1 through 406-4. According to an embodiment, when the USR signal is at a logic level LOW or logic ‘0’, order1 has a selected value of 0, order2 has a selected value of 1, order3 has a selected value of 2, and order4 has a selected value of 3; and when the USR signal is at a logic level HIGH or logic ‘1’, order1 has a selected value of 0, order2 has a selected value of 0, order3 has a selected value of 1, and order4 has a selected value of 1.

In an example, when the USR signal is at a logic level LOW or logic ‘0’, the various drive stages activate in sequence such that drive stage 406-1 outputs PWM1 upon receiving a count value of 0 (compared with an order1 value of 0), drive stage 406-2 outputs PWM2 upon receiving a count value of 1 (compared with an order2 value of 1), drive stage 406-3 outputs PWM3 upon receiving a count value of 2 (compared with an order3 value of 2), and drive stage 406-4 outputs PWM4 upon receiving a count value of 3 (compared with an order4 value of 3). In another example, when the USR signal is at logic level HIGH or logic ‘1’, two or more drive stages are dynamically linked such that they output their PWM signals at substantially the same time (e.g., upon receiving the same count value) such that both drive stages 406-1 and 406-2 output PWM1 and PWM2 together upon receiving a count value of 0 (order1 and order2 are both set to a value of 0), and both drive stages 406-3 and 406-4 output PWM3 and PWM4 upon receiving a count value of 1 (order3 and order4 are both set to a value of 1). It should be understood that the received count signals and order signals may use any number of bits to represent the count value and order value along with the appropriate number of logic gates and/or multiplexers to handle the number of bits being used. Different drive stages may be linked to output their PWM signals together based on the state of the USR signal. For example, a first subset of drive stages may be linked to output their PWM signals together upon receiving a same count value when the USR signal is LOW and a second subset of drive stages may be linked to output their PWM signals together upon receiving a same count value when the USR signal is HIGH. In one particular embodiment, the number of linked drive stages in the linked groups increases when the USR signal is HIGH. For example, linked drive stage groups (e.g., drive stages that output their PWM signals upon receiving the same count value) may each include two drive stages when the USR signal is LOW and then may each include three or more drive stages when the USR signal is high. Numerous other variations will be apparent.

FIG. 6B illustrates an example timing diagram for various signals including the PWM signals output by the aforementioned drive stages 406-1 through 406-4. The example timing diagram reflects the implementation illustrated in FIG. 6A, where four drive stages activate sequentially when the USR signal is LOW and activate in linked groups when the USR signal is HIGH. According to an embodiment, the PWM output signals are activated individually in sequence upon receiving the asserted drive signal during the timeframe when the USR signal is LOW. The count value is also seen increasing from 0 to 3 and back to 0 during this time. However, when the USR signal is HIGH, the PWM1 and PWM2 signals are linked and output together upon reception of the drive signal when the count value is 0, and PWM3 and PWM4 signals are linked and output together upon reception of the following drive signal when the count value is 1. The drive stages may return to individual sequential activation after the USR signal returns to a LOW level.

FIG. 7 illustrates an example of controller 202 along with a more detailed schematic diagram of a single power converter stage 700. In some cases, power converter stage 700 represents any single stage of power converter stages 204. Accordingly, it should be understood that for a multiphase architecture, the output signals from controller 202 to power converter stage 700 would be repeated to each of power converter stages 204. The inductor LOUT may be considered part of power converter stage 700, or may be considered a separate element coupled to the output of power converter stage 700.

According to some embodiments, power converter stage 700 includes a circuit with various input/output (I/O) terminals, such as a power input terminal (PVIN), a bootstrap terminal (BST), a switching node terminal (SW), and a ground terminal (GND). Any number of other I/O terminals may be provided.

According to some embodiments, the power converter circuit includes a high-side switching element (HS) along with an associated high-side driver (HSD) and a low-side switching element (LS) along with an associated low-side driver (LSD). As shown in FIG. 7, both high-side switching element HS and low-side switching element LS may be n-channel MOSFETs, although other suitable switching elements may be used. High-side switching element HS has a first terminal coupled to an input power rail (e.g., PVIN terminal) and a second terminal coupled to the switching node SW of the power converter. Accordingly, the state of high-side driver HSD controls the gate terminal of high-side switching element HS, and high-side switching element HS provides the input voltage on PVIN to switching node SW when the high-side switching element HS is on. Low-side switching element LS has a first terminal coupled to the switching node SW and a second terminal coupled to a ground rail (e.g., at ground terminal GND). The ground terminal GND may be a global ground associated with the chip that includes power converter stage 700. The state of low-side driver LSD controls the gate terminal of low-side switching element LS, and low-side switching element LS provides a ground voltage to switching node SW when the low-side switching element LS is on. Only one of HS and LS can be on at any given time and LS is off whenever HS is on and vice versa.

A boost capacitor Cb may be coupled between the switching node SW and bootstrap terminal BST (or a bootstrap voltage rail) and can be used to provide a boosted voltage that is higher than the output switching voltage at SW in conjunction with a bootstrap charging circuit 702 (e.g., used to charge Cb) between bootstrap terminal BST and input voltage terminal PVIN. This boosted voltage may then be provided to the positive supply rail of the high-side driver HS.

An inductor LOUT may be provided at the switching node SW to smooth out the changing voltage and provide a more stable DC output voltage as VOUT. In some cases, inductor LOUT may be, for example, part of a transformer, or any other suitable energy storage element. A voltage divider that includes resistors R1 and R2 may be provided at the output (e.g. at or near the load) to generate a feedback voltage that is fed to feedback terminal FB of controller 202. It should be noted that, in some embodiments, the feedback voltage FB is not provided by each power converter stage 700 of a multiphase system, but rather at the load output (e.g., the output of the power converter system).

As discussed above, controller 202 provides the control signals (e.g., HS_{PWM} and LS_{PWM}) to the inputs of high-side driver HSD and low-side driver LSD, respectively. According to some embodiments, HS_{PWM} represents the PWM signal output by the drive stage associated with power converter stage 700 to drive the respective high-side switching element HS. The LS_{PWM} signal may be the inverse of HS_{PWM}, according to some examples.

According to some embodiments, controller 202 also receives current feedback I_{FB} from each power converter stage 700 via a current sensing block 704. In some examples, current sensing block 704 includes an arrangement of any number of resistors and/or operational amplifiers to sense the current amplitude at the switching terminal SW.

In this description, the term “couple” may cover connections, communications, or signal paths that enable a functional relationship consistent with this description. For example, if device A generates a signal to control device B to perform an action: (a) in a first example, device A is coupled to device B by direct connection; or (b) in a second example, device A is coupled to device B through intervening component C if intervening component C does not alter the functional relationship between device A and device B, such that device B is controlled by device A via the control signal generated by device A.

A device that is “configured to” perform a task or function may be configured (e.g., programmed and/or hardwired) at a time of manufacturing by a manufacturer to perform the function and/or may be configurable (or reconfigurable) by a user after manufacturing to perform the function and/or other additional or alternative functions. The configuring may be through firmware and/or software programming of the device, through a construction and/or layout of hardware components and interconnections of the device, or a combination thereof.

As used herein, the terms “terminal,” “node,” “interconnection,” “pin,” and “lead” are used interchangeably. Unless specifically stated to the contrary, these terms are generally used to mean an interconnection between or a terminus of a device element, a circuit element, an integrated circuit, a device, or a semiconductor component. Furthermore, a voltage rail or more simply a “rail,” may also be referred to as a voltage terminal and may generally mean a common node or set of coupled nodes in a circuit at the same potential.

A circuit or device that is described herein as including certain components may instead be adapted to be coupled to those components to form the described circuitry or device. For example, a structure described as including one or more semiconductor elements (such as transistors), one or more passive elements (such as resistors, capacitors, and/or inductors), and/or one or more sources (such as voltage and/or current sources) may instead include only the semiconductor elements within a single physical device (e.g., a semiconductor die and/or integrated circuit (IC) package) and may be adapted to be coupled to at least some of the passive elements and/or the sources to form the described structure either at a time of manufacture or after a time of manufacture, such as by an end user and/or a third party.

While the use of particular transistors is described herein, other transistors (or equivalent devices) may be used instead. For example, a p-channel field effect transistor (PFET) may be used in place of an n-channel field effect transistor (NFET) with little or no changes to the circuit. Furthermore, other types of transistors may be used (such as bipolar junction transistors (BJTs)). Furthermore, the devices may be implemented in/over a silicon substrate (Si), a silicon carbide substrate (SiC), a gallium nitride substrate (GaN) or a gallium arsenide substrate (GaAs). Moreover, reference to transistor features such as gate, source, or drain is not intended to exclude any suitable transistor technologies. For instance, features such as source, drain, and gate are typically used to refer to a FET, while emitter, collector, and base are typically used to refer to a BJT. Such features may be used interchangeably herein. For instance, reference to the gate of a transistor may refer to either the gate of a FET or the base of a BJT, and vice-versa. In some examples, a control terminal may refer to either the gate of a FET or the base of a BJT. Any other suitable transistor technologies can be used. Any such transistors can be used as a switch, with the gate or base or other comparable feature acting as a switch select input that can be driven to connect the source and drain (or the emitter and collector, as the case may be).

References herein to a field effect transistor (FET) being “ON” (or a switch being closed) means that the conduction channel of the FET is present, and drain current may flow through the FET. References herein to a FET being “OFF” (or a switch being open) means that the conduction channel is not present, and drain current does not flow through the FET. A FET that is OFF, however, may have current flowing through the transistor's body-diode.

Circuits described herein are reconfigurable to include additional or different components to provide functionality at least partially similar to functionality available prior to the component replacement. Components shown as resistors, unless otherwise stated, are generally representative of any one or more elements coupled in series and/or parallel to provide an amount of impedance represented by the resistor shown. For example, a resistor or capacitor shown and described herein as a single component may instead be multiple resistors or capacitors, respectively, coupled in parallel between the same nodes. For example, a resistor or capacitor shown and described herein as a single component may instead be multiple resistors or capacitors, respectively, coupled in series between the same two nodes as the single resistor or capacitor.

Uses of the phrase “ground” in the foregoing description include a chassis ground, an Earth ground, a floating ground, a virtual ground, a digital ground, a common ground, and/or any other form of ground connection applicable to, or suitable for, the teachings of this description. In this description, unless otherwise stated, “about,” “approximately” or “substantially” preceding a parameter means being within +/−10 percent of that parameter.

### FURTHER EXAMPLES

Example 1 is a circuit that includes a counter and a plurality of drive stages. The counter is arranged to receive a clock signal and output a count signal having a count value that sequentially counts from 0 to N in phase with the clock signal, where N is equal to a number of multiphase power converter phases. Each drive stage of the plurality of drive stages is arranged to receive the count signal from the counter and, based on the count value, output a corresponding signal. At least two of the plurality of drive stages are arranged to output their corresponding signals in response to receiving the count signal having a same count value.

Example 2 includes the circuit of Example 1, wherein the at least two of the plurality of drive stages are configured to output their corresponding signals at a first time, and at least two other drive stages of the plurality of drive stages are configured to output their corresponding signals at a second time non-overlapping with, the first time.

Example 3 includes the circuit of Example 2, wherein the second time is separated from the first time by at least a blanking interval.

Example 4 includes the circuit of Example 1, wherein each drive stage of the plurality of drive stages is configured to output its corresponding signal at substantially the same time.

Example 5 includes the circuit of any one of Examples 1-4, wherein the clock signal is based at least on a state of an undershoot signal.

Example 6 includes the circuit of Example 5, wherein the undershoot signal is in a first state during a period of time that an output voltage of the circuit is changing, and the undershoot signal is in a second state during a period of time that an output voltage of the circuit is substantially constant.

Example 7 includes the circuit of Example 5 or 6, wherein the at least two of the plurality of drive stages are further configured to receive the undershoot signal.

Example 8 includes the circuit of Example 7, wherein the at least two of the plurality of drive stages are further configured to output their corresponding signals upon receiving count signals with different count values from the counter if the undershoot signal is in a first state, and are configured to output their corresponding signals upon receiving a count signal with a same count value from the counter if the undershoot signal is in a second state.

Example 9 includes the circuit of any one of Examples 5-8, wherein each drive stage includes a multiplexer and one or more logic gates. The multiplexer includes a first multiplexer input, a second multiplexer input, a control line configured to receive the undershoot signal, and a multiplexer output having a value equal to a value of the first multiplexer input or the second multiplexer input based on the state of the undershoot signal. The one or more logic gates have a first logic input configured to receive the count signal, a second logic input configured to receive the multiplexer output, and a logic output configured to be in a first state when a value of the first logic input is equal to a value of the second logic input and in a second state when the value of the first logic input is not equal to the value of the second logic input.

Example 10 includes the circuit of any one of Examples 1-8, wherein each drive stage includes a first input configured to receive the count signal, a second input configured to receive an order signal, and a drive stage output. The drive stage output is in a first state in response to the count value being equal to a value of the order signal and is in a second state in response to the count value being different from the value of the order signal.

Example 11 is a system that includes a controller and a plurality of power converter stages. The controller includes a control loop block and a phase manager. The control loop block includes a voltage comparator having a first input configured to receive a reference voltage, a second input configured to receive a feedback voltage from an output of the system, and an output configured to provide a drive signal. The phase manager includes a counter configured to receive a clock signal and output a count signal having a count value that sequentially counts from 0 to N, and a plurality of drive stages. Each drive stage is configured to receive the count signal from the counter and, based on the count value, output a corresponding pulse width modulation (PWM) signal. At least two of the plurality of drive stages are configured to output their corresponding PWM signals in response to receiving a count signal having a same count value. Each power converter stage corresponds to a drive stage of the plurality of drive stages and is configured to receive the PWM signal output by the drive stage.

Example 12 includes the system of Example 11, wherein the at least two of the plurality of drive stages are configured to output their corresponding PWM signals at a first time, and at least two other drive stages of the plurality of drive stages are configured to output their corresponding PWM signals at a second time different from the first time.

Example 13 includes the system of Example 11, wherein each drive stage of the plurality of drive stages are configured to output their corresponding PWM signals at substantially the same time.

Example 14 includes the system of any one of Examples 11-13, wherein the counter is configured to receive a clock signal that is based at least on a state of an undershoot signal, and wherein the counter is configured to sequentially count from 0 to N in phase with the clock signal.

Example 15 includes the system of Example 14, wherein the state of the undershoot signal is based on a transient switching response time of the power converter system.

Example 16 includes the system of Example 15, wherein the undershoot signal is in a first state during a period of time that an output voltage of the power converter system is changing, and the undershoot signal is in a second state during a period of time that an output voltage of the power converter system is substantially constant.

Example 17 includes the system of any one of Examples 14-16, wherein the at least two of the plurality of drive stages are further configured to receive the undershoot signal.

Example 18 includes the system of Example 17, wherein the at least two of the plurality of drive stages are further configured to output their corresponding PWM signals upon receiving count signals with different count values from the counter if the undershoot signal is in a first state, and are configured to output their corresponding PWM signals upon receiving a count signal with a same count value from the counter if the undershoot signal is in a second state.

Example 19 includes the system of any one of Examples 11-18, wherein each drive stage includes a first input configured to receive the count signal, a second input configured to receive an order signal, and a drive stage output. The drive stage output is in a first state in response to the count value being equal to a value of the order signal and is in a second state in response to the count value being different from the value of the order signal.

Example 20 is a circuit that includes a counter and at least two drive stages. The counter is arranged to receive a clock signal and output a count signal having a count value that sequentially counts from 0 to N in phase with the clock signal. The clock signal is based at least on a number of multiphase power converter phases and an undershoot signal. The undershoot signal is based at least on a transient switching response time, and N is equal to the number of phases. Each of the at least two drive stages is arranged to output a corresponding signal upon receiving count signals with different count values from the counter if the undershoot signal is in a first state, and are arranged to output their corresponding signals upon receiving a count signal with a same count value from the counter if the undershoot signal is in a second state.

Example 21 includes the circuit of Example 20, wherein the at least two drive stages are first drive stages, and the circuit further comprises at least two second drive stages configured to output their corresponding signals upon receiving count signals with different count values from the counter if the undershoot signal is in the first state, and are configured to output their corresponding signals upon receiving a count signal from the counter with a same count value if the undershoot signal is in the second state.

Example 22 includes the circuit of Example 20 or 21, wherein the undershoot signal is in the first state during a period of time that an output voltage of the circuit is substantially constant, and the undershoot signal is in the second state during a period of time that an output voltage of the circuit is changing.

Example 23 includes the circuit of any one of Examples 20-22, wherein the at least two drive stages are further configured to receive the undershoot signal.

Example 24 includes the circuit of any one of Examples 20-23, wherein the clock signal is further based at least on a state of a drive signal, wherein the state of the drive signal is based on a comparison between a feedback voltage received from an output of the multiphase power converter and a reference voltage.

Example 25 includes the circuit of any one of Examples 20-24, wherein each drive stage includes a multiplexer and one or more logic gates. The multiplexer includes a first multiplexer input, a second multiplexer input, a control line configured to receive the undershoot signal, and a multiplexer output having a value equal to a value of the first multiplexer input or the second multiplexer input based on the state of the undershoot signal. The one or more logic gates have a first logic input configured to receive the count signal, a second logic input configured to receive the multiplexer output, and a logic output configured to be in a first state when a value of the first logic input is equal to a value of the second logic input and in a second state when the value of the first logic input is not equal to the value of the second logic input.

Modifications are possible in the described examples, and other examples are possible within the scope of the claims.

What is claimed is:

1. A circuit comprising:
a counter configured to receive a clock signal and output a count signal having a count value that sequentially counts from 0 to N in phase with the clock signal, where N is equal to a number of multiphase power converter phases; and
a plurality of drive stages, each drive stage configured to receive the count signal from the counter and, based on the count value, output a corresponding signal, wherein at least two of the plurality of drive stages are configured to output their corresponding signals in response to receiving the count signal having a same count value.

2. The circuit of claim 1, wherein the at least two of the plurality of drive stages are configured to output their corresponding signals at a first time, and at least two other drive stages of the plurality of drive stages are configured to output their corresponding signals at a second time non-overlapping with the first time.

3. The circuit of claim 2, wherein the second time is separated from the first time by at least a blanking interval.

4. The circuit of claim 1, wherein the clock signal is based at least on a state of an undershoot signal.

5. The circuit of claim 4, wherein the undershoot signal is in a first state during a period of time that an output voltage of the circuit is changing, and the undershoot signal is in a second state during a period of time that an output voltage of the circuit is substantially constant.

6. The circuit of claim 4, wherein the at least two of the plurality of drive stages are further configured to output their corresponding signals upon receiving count signals with different count values from the counter if the undershoot signal is in a first state, and are configured to output their corresponding signals upon receiving a count signal with a same count value from the counter if the undershoot signal is in a second state.

7. The circuit of claim 4, wherein each drive stage includes:
a multiplexer having
a first multiplexer input,
a second multiplexer input,
a control line configured to receive the undershoot signal, and
a multiplexer output having a value equal to a value of the first multiplexer input or the second multiplexer input based on the state of the undershoot signal; and
one or more logic gates having
a first logic input configured to receive the count signal,
a second logic input configured to receive the multiplexer output, and
a logic output configured to be in a first state when a value of the first logic input is equal to a value of the second logic input and in a second state when the value of the first logic input is not equal to the value of the second logic input.

8. The circuit of claim 1, wherein each drive stage includes:
a first input configured to receive the count signal;
a second input configured to receive an order signal; and
a drive stage output, wherein the drive stage output is in a first state in response to the count value being equal to a value of the order signal and is in a second state in response to the count value being different from the value of the order signal.

9. A system comprising:
a controller comprising
a control loop block comprising
a voltage comparator having a first input configured to receive a reference voltage, a second input configured to receive a feedback voltage from an output of the system, and an output configured to provide a drive signal; and
a phase manager comprising
a counter configured to output a count signal having a count value that sequentially counts from 0 to N, and
a plurality of drive stages, each drive stage configured to receive the count signal from the counter and, based on the count value, output a corresponding pulse width modulation (PWM) signal, wherein at least two of the plurality of drive stages are configured to output their corresponding PWM signals in response to receiving a count signal having a same count value; and
a plurality of power converter stages, each power converter stage corresponding to a drive stage of the plurality of drive stages and configured to receive the PWM signal output by the respective drive stage.

10. The system of claim 9, wherein the at least two of the plurality of drive stages are configured to output their corresponding PWM signals at a first time, and at least two other drive stages of the plurality of drive stages are configured to output their corresponding PWM signals at a second time different from the first time.

11. The system of claim 9, wherein the counter is configured to receive a clock signal that is based at least on a state of an undershoot signal, and wherein the counter is configured to sequentially count from 0 to N in phase with the clock signal.

12. The system of claim 11, wherein the state of the undershoot signal is based on a transient switching response time of the system.

13. The system of claim 11, wherein the undershoot signal is in a first state during a period of time that an output voltage of the system is changing, and the undershoot signal is in a second state during a period of time that an output voltage of the system is substantially constant.

14. The system of claim 11, wherein the at least two of the plurality of drive stages are further configured to output their corresponding PWM signals upon receiving count signals with different count values from the counter if the undershoot signal is in a first state, and are configured to output their corresponding PWM signals upon receiving a count signal with a same count value from the counter if the undershoot signal is in a second state.

15. The system of claim 11, wherein each drive stage includes:
a first input configured to receive the count signal;
a second input configured to receive an order signal; and
a drive stage output, wherein the drive stage output is in a first state in response to the count value being equal to a value of the order signal and is in a second state in response to the count value being different from the value of the order signal.

16. A circuit comprising:
a counter configured to receive a clock signal and output a count signal having a count value that sequentially counts from 0 to N in phase with the clock signal, wherein the clock signal is based at least on a number of multiphase power converter phases and an undershoot signal, wherein the undershoot signal is based at least on a transient switching response time, and wherein N is equal to the number of phases; and
at least two drive stages each configured to output a corresponding signal, wherein the at least two drive stages are further configured to output their corresponding signals upon receiving count signals with different count values from the counter if the undershoot signal is in a first state, and are configured to output their corresponding signals upon receiving a count signal with a same count value from the counter if the undershoot signal is in a second state.

17. The circuit of claim 16, wherein the at least two drive stages are first drive stages, and the circuit further comprises at least two second drive stages configured to output their corresponding signals upon receiving count signals with different count values from the counter if the undershoot signal is in the first state, and are configured to output their corresponding signals upon receiving a count signal from the counter with a same count value if the undershoot signal is in the second state.

18. The circuit of claim 16, wherein the undershoot signal is in the first state during a period of time that an output voltage of the circuit is substantially constant, and the undershoot signal is in the second state during a period of time that an output voltage of the circuit is changing.

19. The circuit of claim 16, wherein the at least two drive stages are further configured to receive the undershoot signal.

20. The circuit of claim 16, wherein each drive stage includes:
a multiplexer having
a first multiplexer input,
a second multiplexer input,
a control line configured to receive the undershoot signal, and
a multiplexer output having a value equal to a value of the first multiplexer input or the second multiplexer input based on the state of the undershoot signal; and
one or more logic gates having
a first logic input configured to receive the count signal,
a second logic input configured to receive the multiplexer output, and
a logic output configured to be in a first state when a value of the first logic input is equal to a value of the second logic input and in a second state when the value of the first logic input is not equal to the value of the second logic input.
